(19) United States
(12) Patent Application Publication
(10) Pub. No.: US 2015/0380769 A1
(43) Pub. Date: Dec. 31, 2015

(54) NONAQUEOUS ELECTROLYTE SECONDARY BATTERY

(71) Applicant: Panasonic Corporation, Osaka (JP)

(72) Inventors: TAKANOBU CHIGA, Osaka (JP); NAOYA MORISAWA, Hyogo (JP); TAKASHI TAKEUCHI, Osaka (JP)

(21) Appl. No.: 14/730,208

(22) Filed: Jun. 3, 2015

(30) Foreign Application Priority Data
Jun. 30, 2014 (JP) 2014-134807

(51) Int. Cl. H01M 10/0569

(52) U.S. Cl. CPC H01M 10/0569; H01M 2300/0034

(57) ABSTRACT

A nonaqueous electrolyte secondary battery as an example of an embodiment of the present disclosure includes a positive electrode, a negative electrode, and a nonaqueous electrolyte containing a nonaqueous solvent including fluoromethyl propionate. The lithium fluoride (LiF) adheres to a surface of the positive electrode and sulfur (S) compound adheres to a surface of the negative electrode and a proportion of fluorinated solvent is 55% by weight or more to a total weight of the nonaqueous solvent.

### BACKGROUND

1. Technical Field

The present disclosure relates to a nonaqueous electrolyte secondary battery.

2. Description of the Related Art

Japanese Unexamined Patent Application Publication No. 2001-256966 discloses a nonaqueous electrolyte secondary battery. An XPS spectrum obtained through X-ray photoelectron spectroscopy (XPS) of the surface of its positive electrode has a peak for any of sulfur, carbon, or nitrogen in a specified range of binding energies, and the atomic proportions at the surface of the positive electrode meet any of the following conditions: 1% or more sulfur, 3% or more carbon, and 0.3% or more nitrogen. The publication also states that the presence of any one of an organic sulfide, a fluoroalkyl group, and an organic nitride in the coating on the surface of the positive electrode reduces the loss of capacity following storage at high temperatures.

### SUMMARY

Nonaqueous electrolyte secondary batteries are occasionally maintained at high temperatures and high voltages (kept charged). Even in such a situation, the decomposition (side reaction) of the electrolytic solution needs to be reduced for better performance, such as cycle characteristics.

One non-limiting and exemplary embodiment provides a nonaqueous electrolyte secondary battery with reduced side reaction during storage in a charged state (in particular, during that under high-temperature and high-voltage conditions).

In one general aspect, the techniques disclosed here feature a nonaqueous electrolyte secondary battery includes a positive electrode, a negative electrode, and a nonaqueous electrolyte containing a nonaqueous solvent including fluoromethyl propionate (FMP). The lithium fluoride (LiF) adheres to a surface of the positive electrode and sulfur (S) compound adheres to a surface of the negative electrode and a proportion of fluorinated solvent is 55% by weight or more to a total weight of the nonaqueous solvent.

Nonaqueous electrolyte secondary batteries according to the present disclosure are unlikely to undergo side reaction during storage in a charged state and particularly suitable for use in high-voltage applications in which the charge termination voltage is high.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is an XPS spectrum measured from the surface of a positive electrode as an example of an embodiment of the present disclosure; and

FIG. 2 is an XPS spectrum measured from the surface of an negative electrode as an example of an embodiment of the present disclosure.

### DETAILED DESCRIPTION

In an aspect of the present disclosure, a nonaqueous electrolyte includes a positive electrode, a negative electrode, and a nonaqueous electrolyte containing a nonaqueous solvent including fluoromethyl propionate. The lithium fluoride (LiF) adheres to a surface of the positive electrode and sulfur (S) compound adheres to a surface of the negative electrode and a proportion of fluorinated solvent is 55% by weight or more to a total weight of the nonaqueous solvent. For example, a proportion of F derived from the LiF at the surface of the positive electrode can be 2.0 atom % or more to a total quantity of Li, P, S, C, N, O and F, and a proportion of S at the surface of the negative electrode can be 2.0 atom % or more to the total quantity of Li, P, S, C, N, O, and F. For example, a proportion of the FMP to the total weight of the nonaqueous solvent can be 50% by weight or more. For example, the FMP can be 3,3,3-trifluoromethyl propionate. For example, a charge termination voltage can be 4.3 V or more. The following describes an embodiment of the present disclosure in detail.

A nonaqueous electrolyte secondary battery as an embodiment of the present disclosure has a positive electrode, an negative electrode, and a nonaqueous electrolyte containing a nonaqueous solvent. It is desired that a separator be interposed between the positive electrode and the negative electrode. The nonaqueous electrolyte secondary battery can have, for example, a structure in which a wound electrode body, i.e., an electrode body composed of the positive electrode and the negative electrode wound with a separator therebetween, and the nonaqueous electrolyte held together in a package. A multilayer electrode body, which is composed of the positive electrode and the negative electrode stacked with a separator therebetween, can be used instead of a wound electrode body. The nonaqueous electrolyte secondary battery can have any shape, such as cylindrical, prismatic, coin-shaped, button-shaped, and laminated.

The nonaqueous electrolyte secondary battery can have any charge termination voltage, but it is desired that the charge termination voltage is 4.3 V or more, more desirably 4.35 V or more. The nonaqueous electrolyte secondary battery described hereinafter is particularly suitable for use in high-voltage applications in which the battery voltage is 4.3 V or more.

### Positive Electrode

The positive electrode can be composed of, for example, a positive electrode collector (e.g., a metallic foil) and a positive electrode active material layer on the positive electrode collector. The positive electrode collector can be a foil of any metal that is stable in the range of potentials at the positive electrode (e.g., aluminum), a film having a layer of such a metal on its surface, or similar. It is desired that the positive electrode active material layer contain a conductor and a binder in addition to a positive electrode active material. The surface of the particles of the positive electrode active material may be covered with fine particles of an inorganic compound such as aluminum oxide (Al₂O₃) or any similar oxide, a phosphoric acid compound, or a boric acid compound.

Examples of the positive electrode active material include lithium-containing transition metal oxides, i.e., oxides containing transition metal elements such as Co, Mn, and Ni. Examples of lithium-containing transition metal oxides include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (where M is at least one of Na, Mg, Sc, Y, Mn, Fe, Co, Ni, Cu, Zn, Al, Cr, Pb, Sb, and B). In these formulae, 0<x≦1.2 (the value immediately after the production of the active material; x varies with charge and discharge), 0<y≦0.9, and 2.0≦z≦2.3. These materials can be used alone, and it is also possible to use two or more of them in combination.

The conductor enhances the electroconductivity of the positive electrode active material layer. Examples of conductors include carbon materials, such as carbon black, acetylene black, ketjen black, and graphite. These conductors can be used alone, and it is also possible to use two or more of them in combination.

The binder maintains good contact between the positive electrode active material and the conductor and strengthens the bond between the surface of the positive electrode collector and the positive electrode active material and other materials. Examples of binders include polytetrafluoroethylene (PTFE), polyvinylidene fluoride (PVdF), and their altered forms. The binder may be used in combination with a thickener, such as carboxymethyl cellulose (CMC) or polyethylene oxide (PEO). These binders can be used alone, and it is also possible to use two or more of them in combination.

The positive electrode has lithium fluoride (LiF) adhering to its surface. For example, there may be a coating containing LiF on the surface of the positive electrode. The LiF-containing coating reduces the decomposition of the electrolytic solution at the surface of the positive electrode. The LiF-containing coating can be formed through, for example, partial decomposition of fluorinated solvent in the nonaqueous electrolyte, including fluoromethyl propionate (FMP), occurring at the surface of the positive electrode during the initial charge and discharge of the battery.

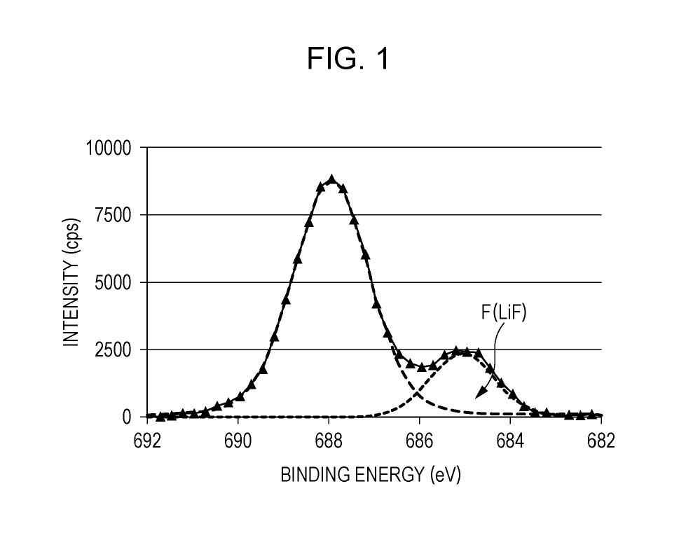

FIG. 1 is an XPS spectrum measured from the surface of a positive electrode as an example of an embodiment. This XPS spectrum was obtained from the positive electrode of a battery in which the nonaqueous solvent was FMP and the nonaqueous electrolyte contained 1,3-propane sultone (PS) (to form a coating containing S on the surface of the negative electrode), one of sultone compounds (described hereinafter). The XPS of the surface of the positive electrode is performed using the positive electrode taken out of the battery in a discharged state after several cycles of charge and discharge (the same applies to the negative electrode). Any adhering electrolytic solution is washed off the removed positive electrode with an appropriate solvent (e.g., FMP if an FMP-based electrolytic solution is used).

The presence of the LiF-containing coating can be confirmed using an XPS spectrum obtained through the XPS of the surface of the positive electrode. As illustrated in FIG. 1, an XPS spectrum measured from the surface of a positive electrode as an example of an embodiment (Example 1) has a peak for LiF in the binding energy range of 683 to 687 eV and a peak for the P—F bond in the range of 684 to 692 eV. The LiF peak can be calculated through peak separation using Gaussian-Lorentzian functions. In FIG. 1, a result of peak separation is indicated by a broken line. The separation of peaks and the calculation of atomic concentrations (described hereinafter) can be performed using, for example, ULVAC-PHI MultiPak VERSION 8.2C.

It is desired that the quantity of F derived from LiF at the surface of the positive electrode be 2.0 atom % or more of the total amount of Li, P, S, C, N, O, and F at the same surface. This means that the concentrations (atom %) of LiF-derived F at the surface of the positive electrode were calculated with the total quantity of major elements making up the coating, i.e., Li, P, S, C, N, O, and F, as 100 atom % (F (derived from LiF) atom %=F (LiF)/[Li+P+S+C+N+O+F (LiF+P—F)]). It is more desired that the quantity of LiF-derived F at the surface of the positive electrode be in the range of 2.0 to 10.0 atom %, for example, 2.0 to 5.0 atom %. This further reduces side reaction.

### Negative Electrode

The negative electrode can be composed of, for example, an negative electrode collector (e.g., a metallic foil) and an negative electrode active material layer on the negative electrode collector. The negative electrode collector can be a foil of any metal that is stable in the range of potentials at the negative electrode (e.g., aluminum or copper), a film having a layer of such a metal on its surface, or similar. It is desired that the negative electrode active material layer contain a binder in addition to an negative electrode active material that stores and releases lithium ions. The negative electrode active material layer may optionally contain a conductor.

Examples of negative electrode active materials that can be used include natural graphite, artificial graphite, lithium, silicon, carbon, tin, germanium, aluminum, lead, indium, gallium, lithium alloys, lithium-storing carbon and silicon, and alloys and mixtures of these substances. The binder can be PTFE or similar as in the case of the positive electrode, but it is desired that the binder be a styrene-butadiene copolymer (SBR), an altered form of it, or similar. The binder may be used in combination with a thickener, such as CMC.

The negative electrode has a sulfur (S) compound adhering to its surface. For example, there may be a coating containing S on the surface of the negative electrode. The S-containing coating reduces the decomposition of the electrolytic solution at the surface of the negative electrode. The S-containing coating can be formed through, for example, the decomposition of a sultone compound in the nonaqueous electrolyte occurring at the surface of the negative electrode during the initial charge and discharge of the battery.

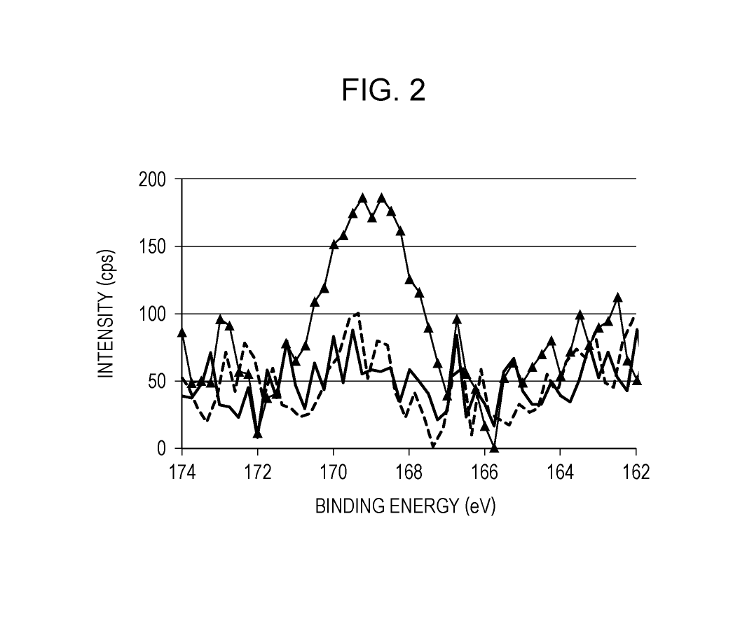

FIG. 2 is an XPS spectrum measured from the surface of an negative electrode as an example of an embodiment (Example 1) (▴). This XPS spectrum was obtained from the negative electrode of a battery in which the nonaqueous solvent was FMP and the nonaqueous electrolyte contained a sultone compound. FIG. 2 also includes XPS spectra measured from the negative electrodes in Comparative Examples 1 and 5 (Comparative Example 1, a broken line; Comparative Example 5, a solid line).

The presence of the S-containing coating can be confirmed using an XPS spectrum obtained through the XPS of the surface of the negative electrode. As illustrated in FIG. 2, an XPS spectrum measured from the surface of an negative electrode as an example of an embodiment has a peak for S in the binding energy range of 162 to 172 eV. If the nonaqueous electrolyte contains no sultone compound, however, no distinct peak is present in the range of 162 to 172 eV.

It is desired that the quantity of S at the surface of the negative electrode be 0.2 atom % or more of the total amount of Li, P, S, C, N, O, and F at the same surface. As in the case of the positive electrode, the concentrations (atom %) of S at the surface of the negative electrode were calculated with the total quantity of major elements making up the coating, i.e., Li, P, S, C, N, O, and F, as 100 atom % (S atom %=S/[Li+P+S+C+N+O+F]). It is more desired that the quantity of S at the surface of the negative electrode be 0.25 atom % or more, in particular, 0.3 atom % or more, for example, 0.3 to 2.0 atom %. This further reduces side reaction.

### Nonaqueous Electrolyte

The nonaqueous electrolyte contains a nonaqueous solvent and an electrolytic salt dissolved in the nonaqueous solvent. The nonaqueous solvent includes at least FMP, with the proportion of fluorinated solvent to the total weight of the nonaqueous solvent being 55% by weight or more. The use of 55% by weight or more fluorinated solvent, in particular, FMP, ensures a good LiF-containing coating will be formed on the surface of the positive electrode. FMP also improves the discharge rate profile by reducing the viscosity of the electrolytic solution. It is desired that the nonaqueous electrolyte contain a sulfone compound as mentioned above. Adding a sultone compound ensures a good S-containing coating will be formed on the surface of the negative electrode. The nonaqueous electrolyte can also be a solid electrolyte, such as a gel polymer electrolyte, rather than a liquid electrolyte (electrolytic solution).

FMP may be the only fluorinated solvent in the nonaqueous solvent, but it is desired that FMP be used in combination with one or more other fluorinated solvents. Examples of fluorinated solvents other than FMP include fluorinated cyclic carbonates, fluorinated linear carbonates, fluorinated linear carboxylates excluding FMP, and mixtures of them. It is desired that the proportion of FMP to the total weight of the nonaqueous solvent be 50% by weight or more, more desirably 50% to 95% by weight.

Examples of the fluorinated cyclic carbonates include 4-fluoroethylene carbonate (FEC), 4,5-difluoro-1,3-dioxolan-2-one, 4,4-difluoro-1,3-dioxolan-2-one, 4-fluoro-5-methyl-1,3-dioxolan-2-one, 4-fluoro-4-methyl-1,3-dioxolane-2-one, 4-trifluoromethyl-1,3-dioxolan-2-one, and 4,5-difluoro-4,5-dimethyl-1,3-dioxolan-2-one (DFBC). In particular, FEC is desired.

Examples of desired fluorinated linear carbonates include partially fluorinated forms of lower linear carbonates, such as dimethyl carbonate, ethyl methyl carbonate, diethyl carbonate, methyl propyl carbonate, ethyl propyl carbonate, and methyl isopropyl carbonate.

Examples of desired fluorinated linear carboxylates other than FMP include partially fluorinated forms of methyl acetate, ethyl acetate, propyl acetate, and ethyl propionate. It is particularly desired that the FMP be 3,3,3-trifluoromethyl propionate.

The nonaqueous solvent may include non-fluorinated solvent. Examples of non-fluorinated solvents include cyclic carbonates, linear carbonates, carboxylates, cyclic ethers, linear ethers, nitriles such as acetonitrile, and amides such as dimethylformamide, and mixtures of them. The proportion of fluorinated solvent to the total weight of the nonaqueous solvent, however, needs to be at least 55% by weight, desirably 60% by weight or more. From the side-reaction reduction perspective, it is desired that the proportion of fluorinated solvent to the total weight of the nonaqueous solvent be in the range of 70% to 100% by weight.

Examples of the cyclic carbonates include ethylene carbonate (EC), propylene carbonate (PC), and butylene carbonate. Examples of the linear carbonates include dimethyl carbonate, methyl ethyl carbonate (EMC), diethyl carbonate, methyl propyl carbonate, ethyl propyl carbonate, and methyl isopropyl carbonate.

Examples of the carboxylates include methyl acetate, ethyl acetate, propyl acetate, methyl propionate (MP), ethyl propionate, and γ-butyrolactone.

Examples of the cyclic ethers include 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers.

Examples of the linear ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

It is desired that the electrolytic salt be a lithium salt. Examples of lithium salts include LiPF₆, LiBF₄, LiAsF₆, LiClO₄, LiCF₃SO₃, LiN(FSO₂)₂, LiN(CₗF₂ₗ₊₁SO₂)(CₘF₂ₘ₊₁SO₂) (where l and m are integers of 1 or more), LiC(CₚF₂ₚ₊₁SO₂)(C_{q}F_{2q+1}SO₂)(CᵣF₂ᵣ₊₁SO₂) (where p, q, and r are integers of 1 or more), Li[B(C₂O₄)₂] (lithium bis(oxalato)borate (LiBOB)), Li[B(C₂O₄)F₂], Li[P(C₂O₄)F₄], and Li[P(C₂O₄)₂F₂]. These lithium salts can be used alone, and it is also possible to use two or more of them in combination.

Examples of the sultone compound include 1,3-propane sultone (PS), 1,4-butane sultone, 2,4-butane sultone, 1,3-propene sultone (PRS), and diphenyl sultone. Sultone compounds can be used alone, and it is also possible to use two or more sultone compounds in combination. PS and PRS are particularly desired. It is desired that the quantity of the sultone compound be in the range of 0.1% to 5% by weight with respect to the nonaqueous electrolyte, more desirably 0.2% to 3.5% by weight, in particular, 0.5% to 3% by weight.

Besides a sultone compound, the nonaqueous electrolyte may contain 1,6-hexamethylene diisocyanate (HDMI), vinylene carbonate (VC), pimelonitrile (PN), or similar.

### Separator

The separator can be an ion-permeable, insulating porous sheet. Specific examples of porous sheets include thin microporous films, woven fabrics, and nonwoven fabrics. It is desired that the separator be made of an olefin polymer, such as polyethylene or polypropylene, cellulose, or similar. The separator may be a multilayer body having a cellulose fiber layer and a fiber layer made from a thermoplastic resin such as an olefin polymer.

### EXAMPLES

The following describes the present disclosure in more detail by providing some examples. The present disclosure is not limited to these examples.

### Example 1

### Preparation of the Positive Electrode

A mixture of 92% by weight LiNi_{0.35}Co_{0.35}Mn_{0.30}O₂, 5% by weight acetylene black, and 3% by weight of polyvinylidene fluoride was kneaded with N-methyl-2-pyrrolidone into slurry. The slurry was applied to an aluminum foil collector as a positive electrode collector and dried, and the collector was rolled to complete the positive electrode.

### Preparation of the Negative Electrode

A mixture of 98% by weight graphite, 1% by weight sodium carboxymethylcellulose, and 1% by weight styrene-butadiene copolymer was kneaded with water into slurry. The slurry was applied to a copper foil collector as an negative electrode collector and dried, and the collector was rolled to complete the negative electrode.

### Preparation of the Nonaqueous Electrolyte

4-Fluoroethylene carbonate (FEC) and 3,3,3-trifluoromethyl propionate (FMP) were mixed in a weight ratio of 11.5:88.5. LiPF₆ was added to the resulting solvent to make a 1.1 mol/l nonaqueous electrolyte. To 100 parts by weight of the obtained nonaqueous electrolyte, 1 part by weight of (1% by weight) 1,3-propane sultone (PS) was added.

### Assembly of the Battery

A lead was attached to each of the positive electrode (30×40 mm) and the negative electrode (32×42 mm). An electrode body in which the positive electrode and the negative electrode faced each other with a separator therebetween was then packaged with the nonaqueous electrolyte in a laminated package made of aluminum. In this way, a nonaqueous electrolyte secondary battery was produced with a design capacity of 50 mAh. The produced battery was subjected to constant-current charge at 0.5 It (25 mA) until the voltage reached 4.35 V. The battery was then charged at a constant voltage of 4.35 V until the current reached 0.05 It (2.5 mA), and allowed to stand for 20 minutes. Subsequently, the battery was subjected to constant-current discharge with 0.5 It (25 mA) until the voltage decreased to 2.5 V. This cycle of charge and discharge was repeated three times to stabilize the battery.

### XPS

After the three cycles of charge and discharge, the positive electrode and the negative electrode were taken out of the battery (in a discharged state). The disassembly of the battery was performed in an Ar box cooled to at least the dew point (−60° C.). Any adhering electrolytic solution was washed off the removed positive electrode and negative electrode with FMP. (In Comparative Examples, EMC was used for an EMC-based electrolytic solution, and MP was used for an MP-based electrolytic solution.) Then the XPS of the surface of each electrode was performed under the following conditions:
Equipment, PHI Quantera SXM, ULVAC-PHI, Inc.;
X-ray source, A1-mono (1486.6 eV, 15 kV/25 W);
Area analyzed, 300 μm×800 μm (scanning microfocus; a 100-μm diameter);
Photoelectron take-off angle, 45°;
Condition of neutralization, neutralization with electrons and floating ions.

The obtained XPS spectrum was used to determine the atomic concentration of LiF-derived F at the surface of the positive electrode and that of S at the surface of the negative electrode.

### Discharge Capacity Measurement

The same battery (25° C.) was charged at 1 C (50 mA) to 4.35 V with a cutoff of 0.05 C (2.25 mA) and then discharged at 1 C (with a cutoff voltage of 2.5 V). The discharge capacity was divided by the weight of the positive electrode active material to determine the capacity per unit weight (mAh/g) of the positive electrode active material.

### Trickle Charge Capacity Measurement

After the measurement of discharge capacity, the battery was charged at 1 C (50 mA) and 4.35 V for 3 days with a battery temperature setting of 60° C. The charge capacity was divided by the weight of the positive electrode active material to determine the capacity per unit weight (mAh/g) of the positive electrode active material.

Table 1 summarizes the nonaqueous solvents used in Example 1, the proportions of the nonaqueous solvents, and the additive in the nonaqueous electrolyte. Table 2 presents the atomic concentration of LiF-derived F at the surface of the positive electrode, the atomic concentration of S at the surface of the negative electrode, discharge capacity (before the trickle charge study), trickle charge capacity, and the amount of side reaction of the battery in Example 1. (Tables 1 and 2 also include data from all other Examples and Comparative Examples.) The amount of side reaction is equal to the trickle charge capacity minus the discharge capacity. The difference between the discharge capacity and the trickle charge capacity is a measure of the extent to which the battery was charged beyond the design capacity. A larger difference between the discharge capacity and the trickle charge capacity therefore indicates more side reaction (decomposition of the electrolytic solution).

### Examples 2 to 12

A battery was produced as in Example 1 except that the nonaqueous solvents, the proportions of the nonaqueous solvents, or the additive in the nonaqueous electrolyte was changed to that indicated in Table 1. The produced battery was evaluated as above.

### Comparative Examples 1 to 7

A battery was produced as in Example 1 except that the nonaqueous solvents, the proportions of the nonaqueous solvents, or the additive in the nonaqueous electrolyte was changed to that indicated in Table 1 (no additive used in Comparative Examples 1, 3, and 5). The produced battery was evaluated as above.

TABLE 1

| | | Proportions of | Proportion of | |
|---|---|---|---|---|
| | | solvents | fluorinated | |
| | Solvents | (weight ratio) | solvent | Additive(s) |
| Example 1 | FEC/FMP | 11.5/88.5 | 100 | PS1 wt % |
| Example 2 | FEC/FMP | 11.5/88.5 | 100 | PRS1 wt % |
| Example 3 | FEC/FMP | 11.5/88.5 | 100 | PS1 wt % + HDMI0.3 wt % |
| Example 4 | FEC/FMP | 11.5/88.5 | 100 | PS2 wt % |
| Example 5 | FEC/FMP | 11.5/88.5 | 100 | PS3 wt % |
| Example 6 | FEC/FMP | 11.5/88.5 | 100 | PS1 wt % + PN0.5 wt % |
| Example 7 | FEC/FMP | 11.5/88.5 | 100 | PS1 wt % + VC1 wt % |
| Example 8 | FEC/FMP | 6/94 | 100 | PS1 wt % |
| Example 9 | FEC/FMP | 28/72 | 100 | PS1 wt % |
| Example 10 | FEC/DFBC/FMP | 11.5/15/73.5 | 100 | PS1 wt % |
| Example 11 | FEC/PC/FMP | 10/10/80 | 90 | PS1 wt % |
| Example 12 | FEC/EMC/FMP | 10/40/50 | 60 | PS1 wt % |
| Comparative | FEC/EMC | 14/86 | 10 | — |
| Example 1 | | | | |
| Comparative | FEC/EMC | 14/86 | 10 | PS1 wt % |
| Example 2 | | | | |
| Comparative | FEC/MP | 15/85 | 10 | — |
| Example 3 | | | | |
| Comparative | FEC/MP | 15/85 | 10 | PS1 wt % |
| Example 4 | | | | |
| Comparative | FEC/FMP | 11.5/88.5 | 100 | — |
| Example 5 | | | | |
| Comparative | FEC/EMC/FMP | 10/50/40 | 50 | PS1 wt % |
| Example 6 | | | | |
| Comparative | EC/PC/FMP | 10/50/40 | 40 | PS1 wt % + VC1 wt % |
| Example 7 | | | | |

TABLE 2

| | Positive | Negative | Proportion of | Discharge | Trickle charge | Amount of | |
|---|---|---|---|---|---|---|---|
| | electrode F | electrode S | fluorinated | capacity | capacity | side | |
| | (LiF) atom % | atom % | solvent | (mAh/g) | (mAh/g) | reaction | |
| Example 1 | 3.5 | 0.4 | 100 | 163 | 182 | 19 | (70%) |
| Example 2 | 2.1 | 1.4 | 100 | 164 | 182 | 18 | (67%) |
| Example 3 | 3.4 | 0.3 | 100 | 163 | 181 | 18 | (67%) |
| Example 4 | 3.8 | 0.6 | 100 | 163 | 182 | 19 | (70%) |
| Example 5 | 3.9 | 1.1 | 100 | 162 | 182 | 20 | (74%) |
| Example 6 | 3.2 | 0.3 | 100 | 163 | 180 | 17 | (63%) |
| Example 7 | 2.9 | 0.3 | 100 | 163 | 181 | 18 | (67%) |
| Example 8 | 2.2 | 0.4 | 100 | 162 | 182 | 20 | (74%) |
| Example 9 | 3.3 | 0.4 | 100 | 163 | 182 | 19 | (70%) |
| Example 10 | 3.5 | 0.3 | 100 | 163 | 180 | 17 | (63%) |
| Example 11 | 3.1 | 0.4 | 90 | 163 | 183 | 20 | (74%) |
| Example 12 | 2.1 | 0.4 | 60 | 163 | 184 | 21 | (78%) |
| Comparative | 1.2 | <0.1 | 10 | 163 | 190 | 27 | (100%) |
| Example 1 | | | | | | | |
| Comparative | 1.1 | 0.4 | 10 | 164 | 191 | 27 | (100%) |
| Example 2 | | | | | | | |
| Comparative | 1.5 | <0.1 | 10 | 162 | 205 | 43 | (159%) |
| Example 3 | | | | | | | |
| Comparative | 1.5 | 0.3 | 10 | 164 | 207 | 43 | (159%) |
| Example 4 | | | | | | | |
| Comparative | 2.5 | <0.1 | 100 | 163 | 187 | 24 | (89%) |
| Example 5 | | | | | | | |
| Comparative | 1.9 | 0.3 | 50 | 163 | 187 | 24 | (89%) |
| Example 6 | | | | | | | |
| Comparative | 1.8 | 0.3 | 40 | 155 | 192 | 37 | (137%) |
| Example 7 | | | | | | | |

In Table 2, the amounts of side reaction of the batteries are also expressed relative to that of the batteries in Comparative Examples 1 and 2 as reference (100%). As can be seen from Tables 1 and 2, the batteries in Examples experienced only limited amounts of side reaction (63% to 78%) as represented by the differences between the trickle charge capacity and the discharge capacity, much less than those experienced by the batteries in Comparative Examples (89% to 159%). Meeting all of the following conditions therefore specifically improves the characteristics of a battery stored under high-temperature and high-voltage conditions in a charged state: the positive electrode has a LiF-containing coating on its surface and the negative electrode has a S-containing coating on its surface; the nonaqueous solvent includes FMP; and the proportion of fluorinated solvent to the total weight of the nonaqueous solvent is 55% by weight or more. In other words, ensuring that the positive electrode has a LiF-containing coating on its surface with the quantity of LiF-derived F at the surface of the positive electrode approximately in the range of 2.0 to 4.0 atom % and that the negative electrode has a S-containing coating on its surface with the quantity of S at the surface of the negative electrode approximately in the range of 0.3 to 1.5 atom % specifically improves the characteristics of the battery during storage in a charged state.

What is claimed is:

1. A nonaqueous electrolyte secondary battery comprising:
a positive electrode;
a negative electrode; and
a nonaqueous electrolyte containing a nonaqueous solvent including fluoromethyl propionate (FMP),
wherein lithium fluoride (LiF) adheres to a surface of the positive electrode and sulfur (S) compound adheres to a surface of the negative electrode,
wherein a proportion of fluorinated solvent is 55% by weight or more to a total weight of the nonaqueous solvent.

2. The nonaqueous electrolyte secondary battery according to claim 1, wherein a proportion of F derived from the LiF at the surface of the positive electrode is 2.0 atom % or more to a total quantity of Li, P, S, C, N, O and F, and a proportion of S at the surface of the negative electrode is 2.0 atom % or more to the total quantity of Li, P, S, C, N, O, and F.

3. The nonaqueous electrolyte secondary battery according to claim 1, wherein a proportion of the FMP to the total weight of the nonaqueous solvent is 50% by weight or more.

4. The nonaqueous electrolyte secondary battery according to claim 1, wherein the FMP is 3,3,3-trifluoromethyl propionate.

5. The nonaqueous electrolyte secondary battery according to claim 1, wherein a charge termination voltage is 43 V or more.
